(19) United States
(12) Patent Application Publication
(10) Pub. No.: US 2013/0070465 A1
(43) Pub. Date: Mar. 21, 2013

(54) HEAT CONDUCTIVE DEVICE FOR A LIGHT-EMITTING DIODE

(71) Applicant: Tsu LEE, Taipei (TW)

(72) Inventor: Tsu LEE, Taipei (TW)

(21) Appl. No.: 13/235,914

(22) Filed: Sep. 19, 2011

(51) Int. Cl. F21V 29/00

(52) U.S. Cl. 362/382

(57) ABSTRACT

A heat conductive device for an LED has a heat sink and an LED carrier tightly fitted in the heat sink. The LED carrier has a mounting portion formed on one end thereof and having a first heat-conducting surface formed on a top of the mounting portion, and a heat-conducting portion formed along a perimeter of the mounting portion and having a second heat-conducting surface formed on the periphery of the heat-conducting portion. The first and second heat-conducting surfaces contact the engagement portion of the heat sink so that heat generated by LED operation is conducted to the heat sink through the heat-conducting portion, the first heat-conducting surface and the second heat-conducting surface. With the second heat-conducting surface of the LED carrier, heat can be more efficiently conducted to the heat sink and LEDs can be operated at an adequate operating temperature to prolong their life duration.

### BACKGROUND OF THE INVENTION

1. Field of the Invention

The present invention relates to a heat conductive device for a light-emitting diode (LED), and more particularly to a heat conductive device having an enhanced heat dissipation efficiency for conducting heat generated by LED.

2. Description of the Related Art

Currently an LED lamp has an LED carrier mounted therein, multiple light-emitting diodes mounted on the LED carrier and a heat sink adjacently connected to the LED carrier. The LED carrier has a heat-dissipating surface formed on a top surface of the LED carrier and contacting the heat sink through a thermal conductive adhesive. Heat generated by lighting the LED lamp can be transferred to a heat-dissipating surface of the heat sink through the LED carrier and the thermal conductive adhesive for the purpose of heat dissipation.

As the foregoing LED carrier only employs the single heat-dissipating surface formed on the top surface of the LED carrier and the heat-dissipating surface is not large enough, heat generated by the LED lamp fails to be effectively transferred to the heat sink for heat dissipation, thereby leading to an unsatisfactory heat-dissipating efficiency. Hence, temperature of the LED lamp increases and the LED lamp is operated under an improper working temperature. Such unfavorable temperature condition inevitably leads to shorter life duration and deteriorates performance of the LED lamp.

Furthermore, the LED carrier and the heat sink can be assembled together by bolts. As a result, air gaps existing between the LED carrier and the heat sink impact on the heat transfer speed and thus give rise to poor heat dissipation of the LED lamp. Additionally, as the LED carrier engages the heat sink, insufficient contact area therebetween further worsens the heat dissipation.

### SUMMARY OF THE INVENTION

An objective of the present invention is to provide a heat conductive device for LED that has an enhanced heat dissipation efficiency for conducting heat generated by LED.

To achieve the foregoing objective, the heat conductive device for an LED has a heat sink and an LED carrier.

The heat sink has a periphery, an inner wall, an engagement portion and a chamber. The engagement portion is annularly formed on the inner wall. The chamber is defined in the heat sink and surrounded by the engagement portion.

The LED carrier engages the heat sink, is mounted in the chamber, and has a mounting portion and a heat-conducting portion. The mounting portion is formed on one end of the LED carrier and has a first heat-conducting surface formed on a top of the mounting portion. The heat-conducting portion is annularly formed along and protrudes from a perimeter of the mounting portion and has a periphery and a second heat-conducting surface. The second heat-conducting surface is formed on the periphery of the heat-conducting portion.

Both the first heat-conducting surface and the second heat-conducting surface contact the engagement portion of the heat sink.

The heat conductive device for an LED can be mounted in an LED lamp. The mounting portion serves to be mounted by LED. Heat generated by operating LED is conducted to the LED carrier and is further conducted to the heat sink through the first heat-conducting surface and the second heat-conducting surface for heat dissipation. As the first heat-conducting surface and the second heat-conducting surface contact the heat sink, air gaps between the heat sink and the first heat-conducting surface or the second heat-conducting surface are reduced and the contact area of heat conduction increases. Accordingly, the heat conduction performance is enhanced, the heat sink can effectively dissipate heat and LED is operated at a suitable temperature and its life duration is prolonged.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a heat conductive device for an LED in accordance with the present invention;

FIG. 2 is a side view in partial section of the heat conductive device in FIG. 1;

FIG. 3 is a side view in partial section of a second embodiment of a heat conductive device for an LED in accordance with the present invention;

FIG. 4 is a side view in partial section of an LED lamp having the heat conductive device in FIG. 1 mounted therein; and

FIG. 5 is an operational side view in partial section showing heat dissipation paths of the heat conductive device in FIG. 1.

### DETAILED DESCRIPTION OF THE INVENTION

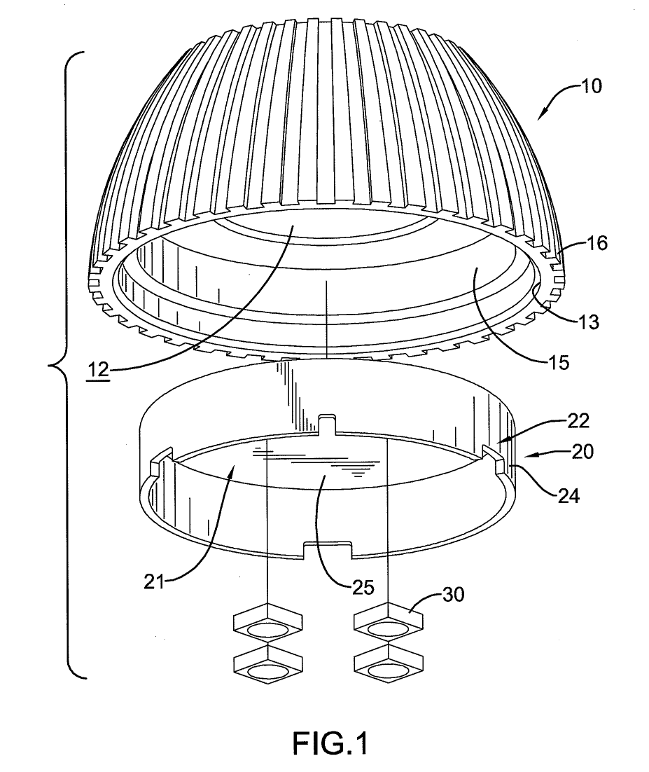

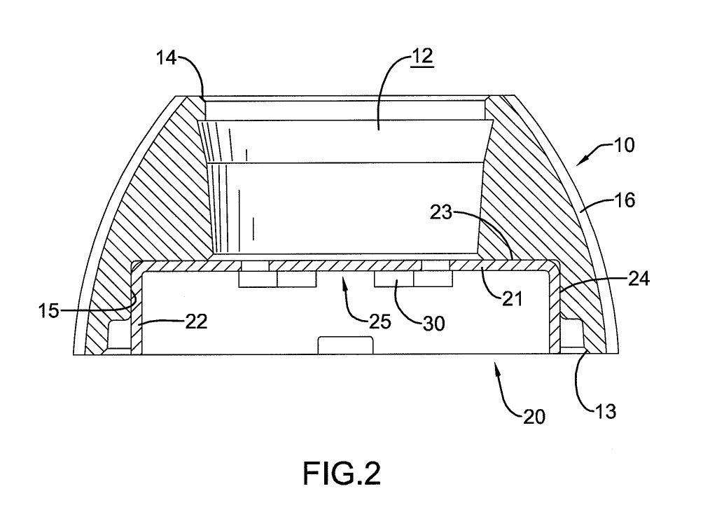

With reference to FIGS. 1 and 2, a first embodiment of a heat conductive device for an LED in accordance with the present invention has a heat sink 10 and an LED carrier 20.

The heat sink 10 has a chamber 12, a first opening 13, a second opening 14 and an engagement portion 15. The chamber 12 is defined in the heat sink 10. The first opening 13 and the second opening 14 are respectively formed through two opposite ends of the heat sink 10 and communicate with the chamber 12 and the first opening 13 is larger than the second opening 14 in diameter. The engagement portion 15 is annularly formed on an inner wall of the heat sink 10 and around the chamber 12. In the present embodiment, the heat sink 10 further has multiple heat-dissipating fins 16 formed on and protruding from a periphery of the heat sink 10 and mutually spaced by a gap.

The LED carrier 20 is cylindrical and has an open end, engages the heat sink 10, is mounted in the chamber 12, and has a mounting portion 21 and a heat-conducting portion 22. The mounting portion 21 is formed on the other end of the LED carrier 20, which is opposite to the open end, and has a first heat-conducting surface 23 and a working area 25. The first heat-conducting surface 23 is formed on a top of the mounting portion 21. The heat-conducting portion 22 is annularly formed along and protrudes from a perimeter of the mounting portion 21 and has a second heat-conducting surface 24 formed on a periphery of the heat-conducting portion 22. The second heat-conducting surface 24 is adjacent to the first opening 13 of the heat sink 10. Both the first heat-conducting surface 23 and the second heat-conducting surface 24 contact the engagement portion 15 of the heat sink 10. The working area 25 is centrally formed on a bottom of the mounting portion 21 and is adjacent to the first heat-conducting surface 23.

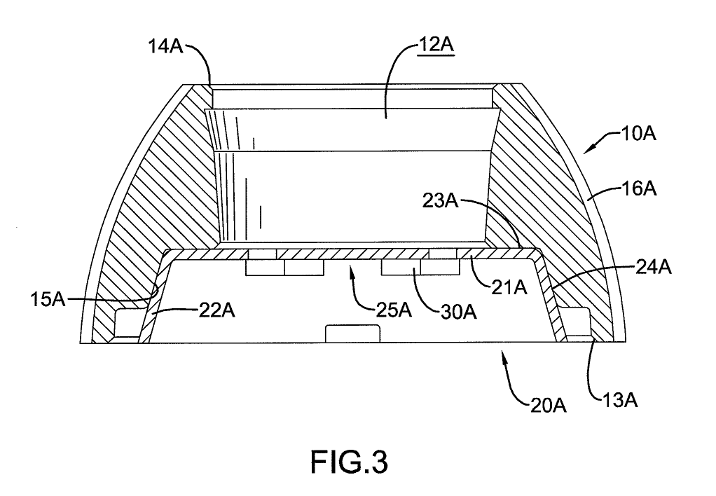

With reference to FIG. 3, a second embodiment of a heat conductive device for an LED in accordance with the present invention is shown. The heat-conducting portion 22A is tapered in a direction from the first opening 13A to the second opening 14A and an outer diameter of a bottom of the heat-conducting portion 22A is larger than that of the first heat-conducting surface 23A so that the LED carrier 20A can be tightly fitted into the heat sink 10A. The engagement portion 15A of the heat sink 10A is conical in contrast to the cylindrical engagement portion 15 in the first embodiment. The second heat-conducting surface 24A of the LED carrier 20A is conical in contrast to the cylindrical second heat-conducting surface 24 in the first embodiment, and is fitted in the engagement portion 15A.

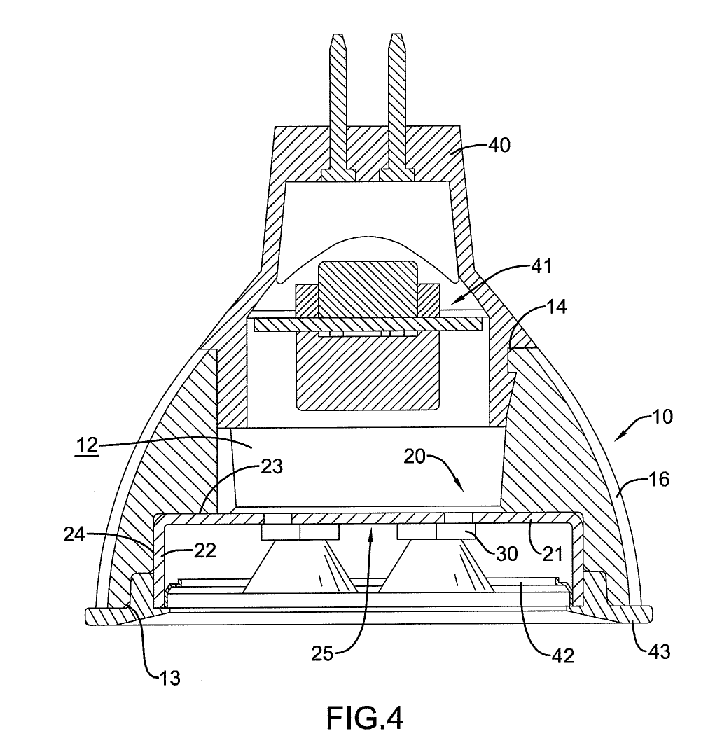

With reference to FIG. 4, the heat conductive device for an LED can be mounted in an LED lamp. The LED lamp further has a lamp seat 40, multiple LEDs 30, a light cup unit 42 and a positioning element 43. The lamp seat 40 is mounted in the heat sink 10 of the heat conductive device for an LED through the second opening 14 to be assembled with the heat sink 10, and has a control module 41. The LEDs 30 are mounted on the working area 25 of the LED carrier 20 and are electrically connected with the control module 41. The light cup unit 42 is mounted in collaboration with the LEDs 30. The positioning element 43 is mounted in the heat sink 10 through the first opening 13 to position the light cup unit 42.

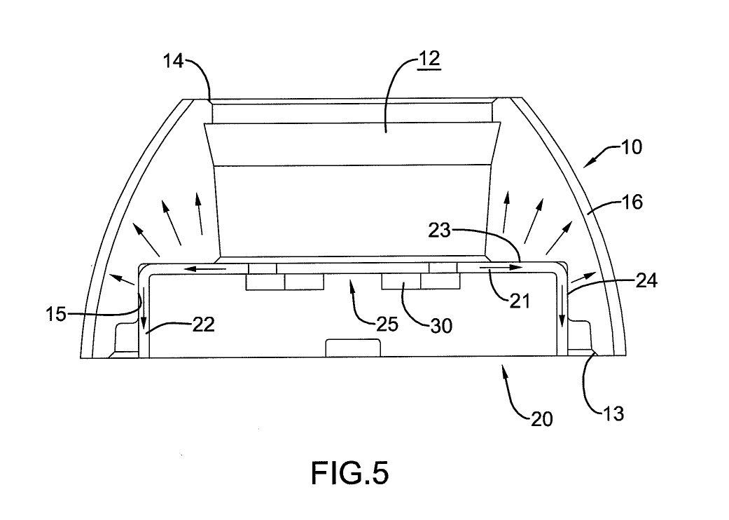

With reference to FIG. 5, heat generated by operating the LEDs 30 is conducted to the mounting portion 21 and the heat-conducting portion 22 first and is further conducted to the heat sink 10 through the first heat-conducting surface 23 and the second heat-conducting surface 24 for heat dissipation.

In sum, the first heat-conducting surface 23 and the second heat-conducting surface 24 of the heat conductive device for an LED abut against the heat sink 10 to increase the contact area between the LED carrier 20 and the heat sink 10, and the second heat-conducting surface 24 is tightly fitted in the engagement portion 15 to reduce air amount between the second heat-conducting surface 24 and the engagement portion 15. Accordingly, heat generated from the LEDs 30 and conducted to the LED carrier 20 can be more effectively transferred to the heat sink to improve the heat dissipation efficiency of the heat sink 10. Due to the effective heat conduction of the LED carrier and the effective heat dissipation of the heat sink 10, the LEDs 30 can be operated at a suitable operating temperature so as to enhance the operating efficiency and prolong life duration of the LED lamp.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A heat conductive device for an LED comprising:
a heat sink having:
a periphery;
an inner wall;
an engagement portion annularly formed on the inner wall; and
a chamber defined in the heat sink and surrounded by the engagement portion;
an LED carrier engaging the heat sink, mounted in the chamber, and having:
a mounting portion formed on one end of the LED carrier and having a first heat-conducting surface formed on a top of the mounting portion; and
a heat-conducting portion annularly formed along and protruding from a perimeter of the mounting portion and having:
a periphery; and
a second heat-conducting surface formed on the periphery of the heat-conducting portion;
wherein both the first heat-conducting surface and the second heat-conducting surface contact the engagement portion of the heat sink.

2. The heat conductive device for an LED as claimed in claim 1, wherein the mounting portion of the LED carrier has a working area centrally formed on a bottom of the mounting portion and being adjacent to the first heat-conducting surface.

3. The heat conductive device for an LED as claimed in claim 1, wherein the heat sink further has multiple heat-dissipating fins formed on and protruding from the periphery of the heat sink and mutually spaced by a gap.

4. The heat conductive device for an LED as claimed in claim 2, wherein the heat sink further has multiple heat-dissipating fins formed on and protruding from the periphery of the heat sink and mutually spaced by a gap.

5. The heat conductive device for an LED as claimed in claim 3, wherein the heat sink further has a first opening and a second opening respectively formed through two opposite ends of the heat sink and communicating with the chamber, and the first opening is larger than the second opening in diameter.

6. The heat conductive device for an LED as claimed in claim 4, wherein the heat sink further has a first opening and a second opening respectively formed through two opposite ends of the heat sink and communicating with the chamber, and the first opening is larger than the second opening in diameter.

7. The heat conductive device for an LED as claimed in claim 1, wherein the heat-conducting portion is tapered in a direction from the first opening to the second opening and an outer diameter of a bottom of the heat-conducting portion is larger than that of the first heat-conducting surface.

8. The heat conductive device for an LED as claimed in claim 2, wherein the heat-conducting portion is tapered in a direction from the first opening to the second opening and an outer diameter of a bottom of the heat-conducting portion is larger than that of the first heat-conducting surface.

9. The heat conductive device for an LED as claimed in claim 5, wherein the heat-conducting portion is tapered in a direction from the first opening to the second opening and an outer diameter of a bottom of the heat-conducting portion is larger than that of the first heat-conducting surface.

10. The heat conductive device for an LED as claimed in claim 6, wherein the heat-conducting portion is tapered in a direction from the first opening to the second opening and an outer diameter of a bottom of the heat-conducting portion is larger than that of the first heat-conducting surface.

11. The heat conductive device for an LED as claimed in claim 1, wherein
the engagement portion of the heat sink is conical, and
the second heat-conducting surface of the LED carrier is conical and is fitted in the engagement portion.

12. The heat conductive device for an LED as claimed in claim 2, wherein
the engagement portion of the heat sink is conical, and
the second heat-conducting surface of the LED carrier is conical and is fitted in the engagement portion.

13. The heat conductive device for an LED as claimed in claim 5, wherein
the engagement portion of the heat sink is conical, and
the second heat-conducting surface of the LED carrier is conical and is fitted in the engagement portion.

14. The heat conductive device for an LED as claimed in claim 6, wherein
the engagement portion of the heat sink is conical, and
the second heat-conducting surface of the LED carrier is conical and is fitted in the engagement portion.

15. The heat conductive device for an LED as claimed in claim 9, wherein
the engagement portion of the heat sink is conical, and
the second heat-conducting surface of the LED carrier is conical and is fitted in the engagement portion.

16. The heat conductive device for an LED as claimed in claim 10, wherein
the engagement portion of the heat sink is conical, and
the second heat-conducting surface of the LED carrier is conical and is fitted in the engagement portion.
